(19) United States
(12) Patent Application Publication
(10) Pub. No.: US 2006/0067803 A1
(43) Pub. Date: Mar. 30, 2006

(54) Self-drilling wall anchor device

(76) Inventor: Chin Jen Hsu, Kaoshiung Hsien (TW)

Correspondence Address: CHARLES E. BAXLEY, ESQ., 90 JOHN STREET, THIRD FLOOR, NEW YORK, NY, 10038, US

(21) Appl. No.: 10/950,742

(22) Filed: Sep. 27, 2004

(51) Int. Cl. F16B 13/04

(52) U.S. Cl. 411/29

(57) ABSTRACT

A wall anchor device includes an outer anchor sleeve having an outer peripheral lip, one or more peripheral flanges extended outwardly from the middle portion for engaging with a wall member. The outer anchor sleeve includes an inner end having an inner thread. An insert is engageable into the outer anchor sleeve and includes an outer end for being driven by a tool, and an outer thread for threading with the inner thread of the outer anchor sleeve. A drill element is secured to the insert, to drill and move the anchor sleeve into the wall. The peripheral flanges of the outer anchor sleeve may be expanded and engaged into the wall member, to solidly secure the outer anchor sleeve to the wall member.

### BACKGROUND OF THE INVENTION

1. Field of the Invention

The present invention relates to a wall anchor device, and more particularly to a self-drilling wall anchor device having an expandable and threaded structure for solidly engaging or securing to wall members or the like.

2. Description of the Prior Art

Various kinds of typical wall anchor devices have been developed, and comprise a threaded fastener threaded in an expandable outer casing, to expand the outer casing and thus to engage and secure the wall anchor devices to wall members or the like.

For example, U.S. Pat. No. 3,316,796 to Young discloses one of the typical wall anchor devices which also comprises a threaded bolt threaded in an expansible anchor sleeve, to expand the expansible anchor sleeve and thus to engage and secure the wall anchor devices to wall members or the like.

The expansible anchor sleeve includes a number of connecting bands bowed slightly outwardly in the provision of angularly inclined legs. However, the angularly inclined legs of the expansible anchor sleeve include a planar outer surface and may only be bent, but may not be forced to engage into the wall members, such that the typical expansible anchor sleeve may not be solidly secured or anchored in blind holes of wall members.

U.S. Pat. No. 4,601,625 to Ernst et al. discloses another typical wall anchor device which comprises an insert having a drilling blade for drilling into wall members or the like, and a threaded bolt threaded into the insert, to deflect the blade laterally, and thus to disengage the blade from the insert. However, the insert of the typical anchor device includes a planar outer surface and may not be expanded and thus may not be solidly secured or anchored in blind holes of wall members.

U.S. Pat. No. 4,617,692 to Bond et al. discloses a further typical wall anchor device which comprises a threaded bolt threaded in an expansible screw anchor, and rotatable by a handle, to expand the expansible screw anchor and thus to engage and secure the wall anchor devices to wall members or the like. However, similarly, the expansible screw anchor includes a planar outer surface and may only be bent, but may not be forced to engage into the wall members, such that the typical expansible screw anchor also may not be solidly secured or anchored in blind holes of wall members.

U.S. Pat. No. 5,147,166 to Harker discloses a still further typical wall anchor device comprising a threaded bolt threaded in an expansible body element, to expand the expansible body element and thus to engage and secure the wall anchor devices to wall members or the like. However, similarly, the angularly inclined legs of the expansible body element include a planar outer surface and may only be bent, but may not be forced to engage into the wall members, such that the typical expansible body element may not be solidly secured or anchored in blind holes of wall members.

The present invention has arisen to mitigate and/or obviate the afore-described disadvantages of the conventional wall anchor devices.

### SUMMARY OF THE INVENTION

The primary objective of the present invention is to provide a self-drilling wall anchor device including an expandable and threaded structure for solidly engaging or securing to wall members or the like.

In accordance with one aspect of the invention, there is provided a wall anchor device for engaging and anchoring into a wall member, the wall anchor device comprising an outer anchor sleeve including an outer end portion having a peripheral lip extended radially and outwardly therefrom, and including a middle portion having at least one peripheral flange extended outwardly therefrom, for engaging with the wall member, and for anchoring the outer anchor sleeve to the wall member, the outer anchor sleeve including a bore formed therein, and including an inner end portion having an inner thread formed therein, an insert engageable into the bore of the outer anchor sleeve and including an outer end having an engaging hole formed therein for receiving a driving shank of a tool, and for allowing the insert to be rotated and driven by the driving shank, the insert including an outer thread formed thereon for threading with the inner thread of the outer anchor sleeve, and including an inner end portion, and a drill element secured to the inner end portion of the insert, to allow the drill element to be rotated and driven by the insert. The drill element is rotatable by the driving shank via the insert for drilling into the wall member, and for engaging the outer anchor sleeve into the wall member until the peripheral lip of the outer anchor sleeve is engaged with the wall member, and the outer thread of the insert is threadable with the inner thread of the outer anchor sleeve when the peripheral lip of the outer anchor sleeve is engaged with the wall member, to expand the middle portion of the outer anchor sleeve, and to force the peripheral flange to engaged into the wall member, and to solidly secure the outer anchor sleeve to the wall member.

The peripheral flange of the outer anchor sleeve is a helical flange. The outer anchor sleeve includes at least one longitudinal slot formed in the middle portion thereof, to facilitate bending of the middle portion of the of the outer anchor sleeve.

The middle portion of the outer anchor sleeve includes a smaller outer diameter than that of the outer and the inner end portions of the outer anchor sleeve, to form at least one annular shoulder between the middle portion and the outer and the inner end portions of the outer anchor sleeve, and to facilitate bending of the middle portion of the of the outer anchor sleeve.

The outer anchor sleeve includes an peripheral groove formed in the middle portion thereof, to facilitate bending of the middle portion of the of the outer anchor sleeve. The outer anchor sleeve includes a cone-shaped opening formed in the outer end portion thereof and communicating with the bore thereof, and the insert includes an enlarged head formed on the outer end thereof and receivable in the cone-shaped opening of the outer anchor sleeve.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a self-drilling wall anchor device in accordance with the present invention;

FIG. 2 is a partial exploded view of the self-drilling wall anchor device;

FIG. 3 is a perspective view illustrating an outer anchor sleeve of the self-drilling wall anchor device, in which one half of the outer anchor sleeve has been cut off to show an inner structure of the outer anchor sleeve;

FIG. 4 is a perspective view similar to FIG. 3, illustrating another arrangement of the outer anchor sleeve;

FIG. 5 is a partial exploded view illustrating an insert of the self-drilling wall anchor device;

FIG. 6 is a cross sectional view of the self-drilling wall anchor device taken along lines 6-6 of FIG. 1;

FIG. 7 is a cross sectional view similar to FIG. 6, illustrating the other arrangement of the insert of the self-drilling wall anchor device;

FIG. 8 is a cross sectional view similar to FIG. 6, illustrating the operation of the self-drilling wall anchor device; and

FIGS. 9, 10, 11 are cross sectional views similar to FIG. 8, illustrating the operation of the self-drilling wall anchor device.

### DETAILED DESCRIPTION OF THE PREFERRED EMBODIMENT

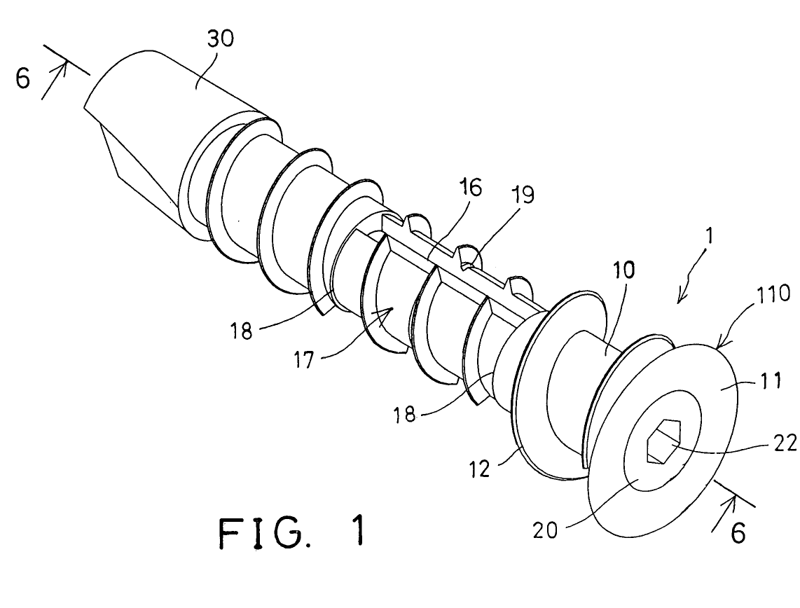

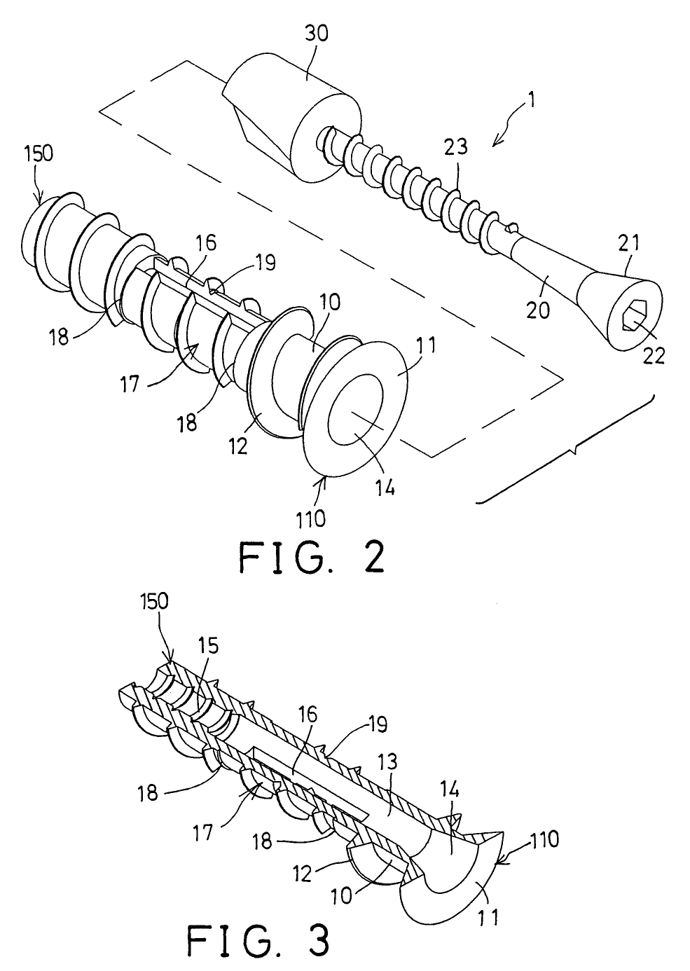

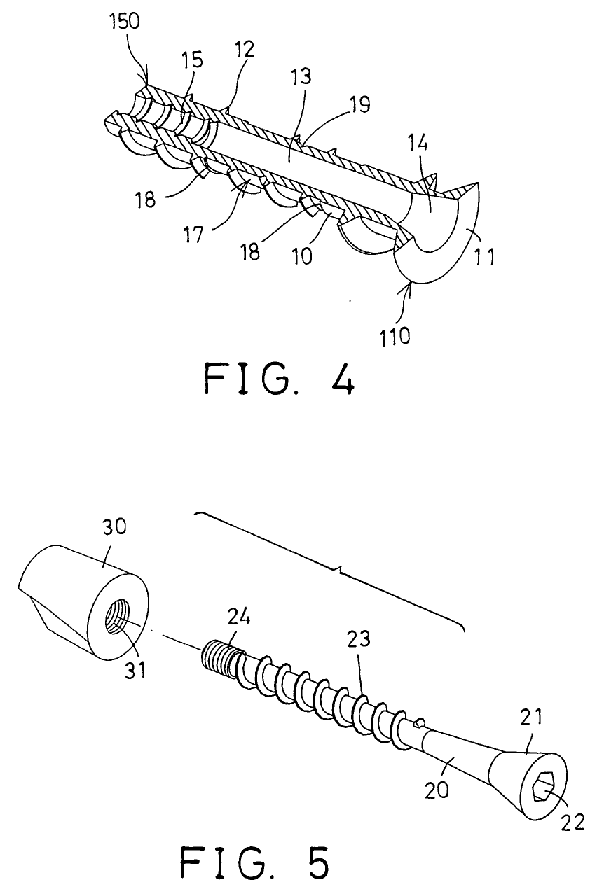

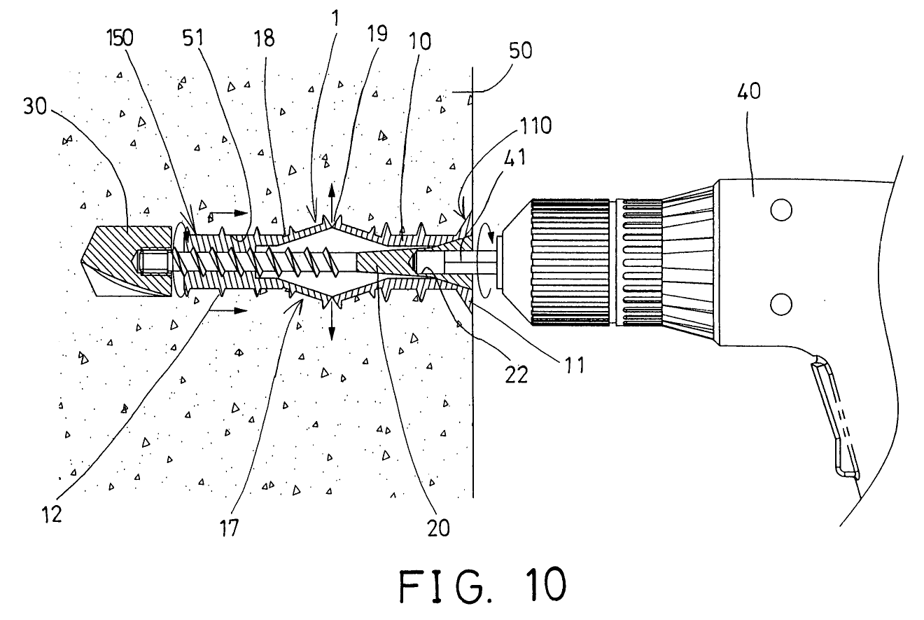

Referring to the drawings, and initially to FIGS. 1-3, a self-drilling wall anchor device 1 in accordance with the present invention comprises an outer anchor sleeve 10 including a peripheral lip 11 extended radially and outwardly from one end or outer end 110 thereof for engaging with or for anchoring the outer anchor sleeve 10 to wall members 50 or the like, and including one or more peripheral flanges or a helical flange 12 extended outwardly, for engaging with the wall members 50 (FIGS. 8-11), and for allowing the outer anchor sleeve 10 of the self-drilling wall anchor device 1 to be solidly secured to the wall members 50.

The outer anchor sleeve 10 includes a bore 13 formed therein, a cone-shaped opening 14 formed in the outer end portion 110 thereof and communicating with the bore 13 thereof, an inner thread 15 formed in the inner end portion 150 thereof and also communicating with the bore 13 thereof, and one or more longitudinal slots 16 formed in a middle portion 17 thereof, and also communicating with the bore 13 thereof, for allowing the middle portion 17 of the outer anchor sleeve 10 to be easily bent or expanded than the outer and the inner end portions 110, 150 of the outer anchor sleeve 10.

It is preferable that the middle portion 17 of the outer anchor sleeve 10 includes a smaller outer diameter than that of the outer and the inner end portions 110, 150 thereof, to form two annular shoulders 18 between the middle portion 17 and the outer and the inner end portions 110, 150 of the outer anchor sleeve 10 respectively, and thus for allowing the middle portion 17 of the outer anchor sleeve 10 to be easily bent than the outer and the inner end portions 110, 150 of the outer anchor sleeve 10 (FIGS. 10, 11).

It is also preferable that the middle portion 17 of the outer anchor sleeve 10 includes an annular or peripheral groove 19 formed in the outer peripheral portion thereof, to further allow the middle portion 17 of the outer anchor sleeve 10 to be easily bent relative to the outer and the inner end portions 110, 150 of the outer anchor sleeve 10 (FIGS. 10, 11) at the annular or peripheral groove 19 of the outer anchor sleeve 10.

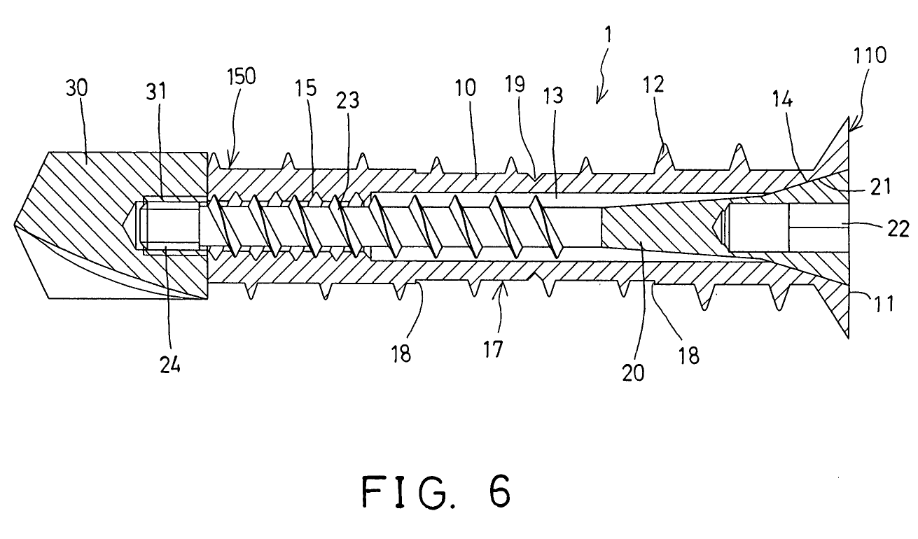

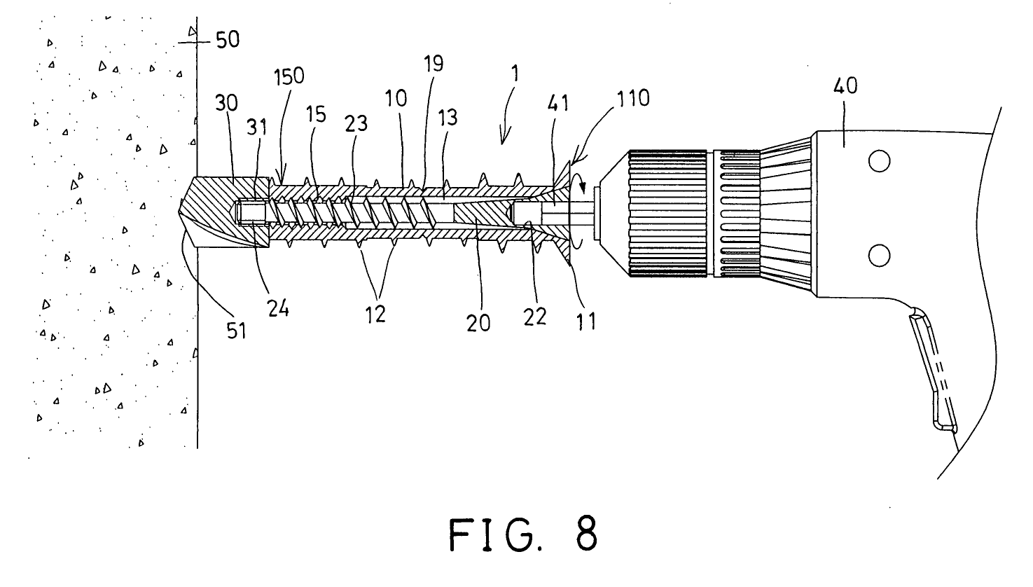

Alternatively, as shown in FIGS. 4 and 6, the outer anchor sleeve 10 may also have no longitudinal slots formed in the middle portion 17 thereof. The middle portion 17 of the outer anchor sleeve 10 may also be easily bent relative to the outer and the inner end portions 110, 150 of the outer anchor sleeve 10 at the annular or peripheral groove 19 of the outer anchor sleeve 10, or at the annular shoulders 18 formed between the middle portion 17 and the outer and the inner end portions 110, 150 of the outer anchor sleeve 10 respectively, without the slots 16 of the anchor sleeve 10.

The self-drilling wall anchor device 1 includes an insert 20 engageable into the bore 13 of the outer anchor sleeve 10, and having an enlarged head 21 formed or provided on one end or outer end thereof and receivable in the cone-shaped opening 14 of the outer end portion 110 of the outer anchor sleeve 10, and having a non-circular engaging hole 22 formed in the enlarged head 21, for receiving a driving shank 41 of such as a power driving tool 40 (FIGS. 8-11), and for allowing the insert 20 to be rotated or driven by the driving shank 41 of the power driving tool 40 or other driving tools (not shown).

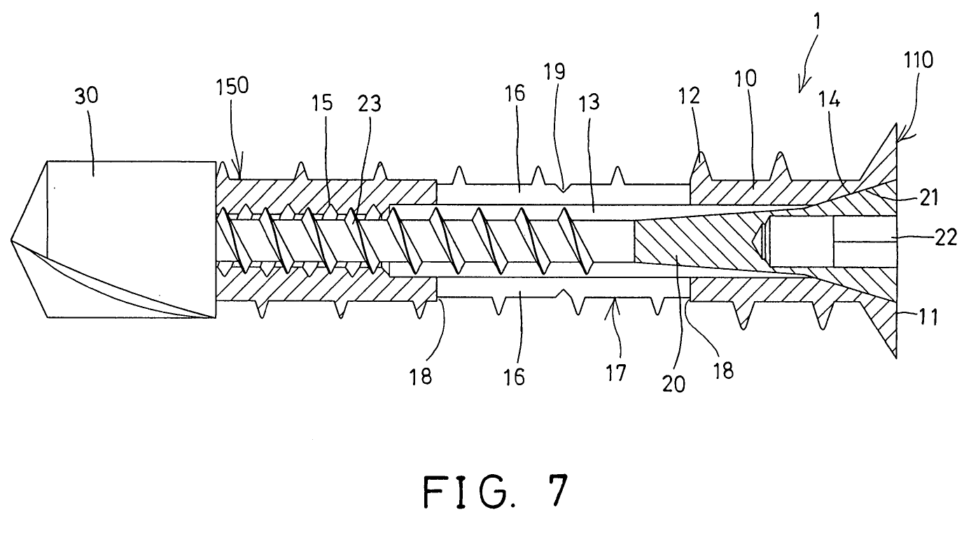

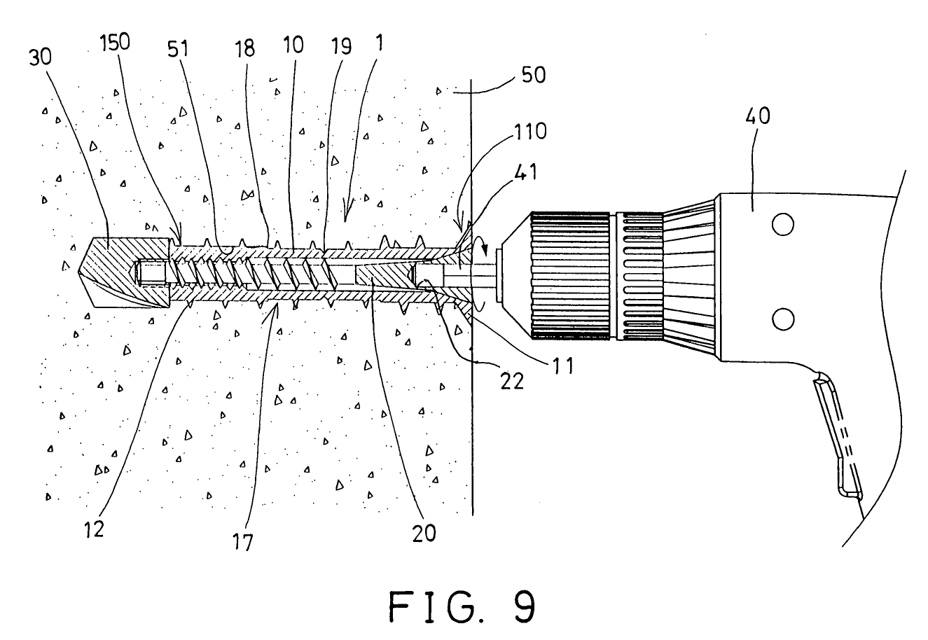

The insert 20 includes an outer thread 23 formed in the middle portion thereof for threading with the inner thread 15 of the outer anchor sleeve 10, and another outer thread 24 formed in the other end or the inner end portion thereof, for threading with an inner thread 31 of a drill element 30 (FIGS. 5, 6), and for securing the insert 20 to the drill element 30, and thus for allowing the drill element 30 to be rotated or driven by the insert 20. The drill element 30 may also be solidly secured to the insert 20 by such as welding processes or the like (FIGS. 7, 11).

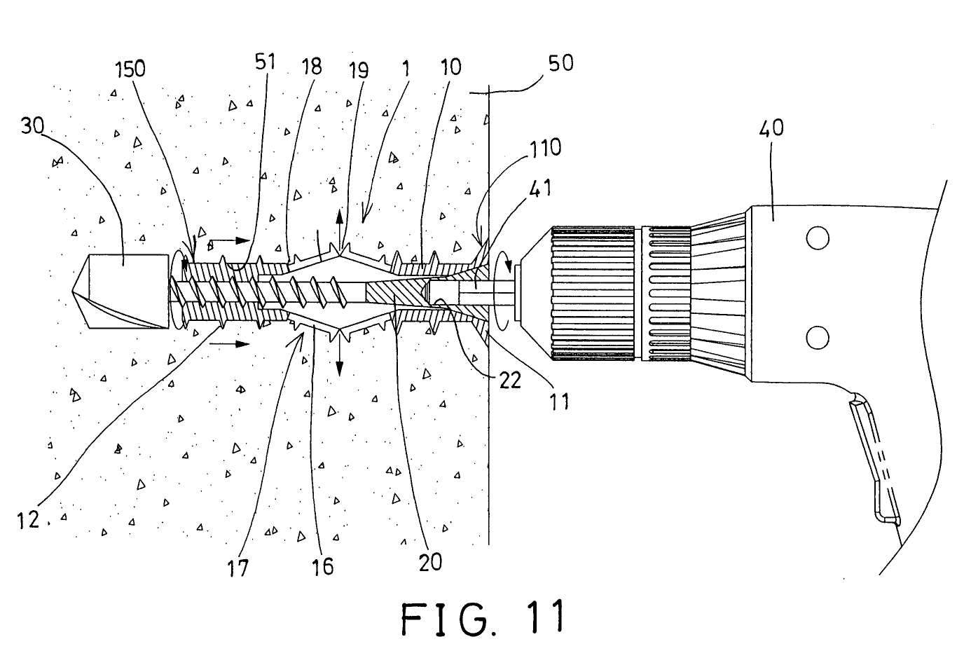

In operation, as shown in FIG. 8, the drill element 30 may be rotated or driven by the driving shank 41 of the driving tool 40 via the insert 20, in order to drill a hole 51 in the wall member 50 or the like. As shown in FIG. 9, the drill element 30 may further be rotated or driven into the wall member 50 or the like by the driving shank 41 of the driving tool 40 until the peripheral lip 11 of the outer anchor sleeve 10 is engaged with or anchored to the wall members 50 or the like.

When the drill element 30 is further rotated or driven by the driving shank 41 of the driving tool 40, as shown in FIG. 10, the outer anchor sleeve 10 may no longer be engaged into the wall members 50, and the insert 20 may be forced to rotate relative to the outer anchor sleeve 10, and to expand the thinner or expandable middle portion 17 of the outer anchor sleeve 10, and to allow the middle portion 17 of the outer anchor sleeve 10 to be easily bent or expanded relative to the outer and the inner end portions 110, 150 of the outer anchor sleeve 10.

The provision of the annular shoulders 18 between the middle portion 17 and the outer and the inner end portions 110, 150 of the outer anchor sleeve 10, and/or the annular or peripheral groove 19 of the outer anchor sleeve 10, and/or the slots 16 of the anchor sleeve 10 allows the middle portion 17 of the outer anchor sleeve 10 to be easily bent relative to the outer and the inner end portions 110, 150 of the outer anchor sleeve 10.

The peripheral flanges or the helical flange 12 of the outer anchor sleeve 10 may further be forced to engage into the wall members 50 (FIGS. 10-11), to allow the outer anchor sleeve 10 of the self-drilling wall anchor device 1 to be solidly secured to the wall members 50 or the like and to be prevented from being disengaged from the wall members 50.

Accordingly, the self-drilling wall anchor device in accordance with the present invention includes an expandable and threaded structure for solidly engaging or securing to wall members or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A wall anchor device for engaging and anchoring into a wall member, said wall anchor device comprising:
an outer anchor sleeve including an outer end portion having a peripheral lip extended radially and outwardly therefrom, and including a middle portion having at least one helical peripheral flange extended outwardly therefrom, for engaging with the wall member, and for anchoring said outer anchor sleeve to the wall member, said outer anchor sleeve including a bore formed therein, and including an inner end portion having an inner thread formed therein, said outer anchor sleeve including at least one longitudinal slot formed in said middle portion thereof to facilitate bending of said middle portion of said outer anchor sleeve, said middle portion of said outer anchor sleeve including a smaller outer diameter than that of said outer and said inner end portions of said outer anchor sleeve to form at least one annular shoulder between said middle portion and said outer and said inner end portions of said outer anchor sleeve and to facilitate bending of said middle portion of said outer anchor sleeve, and said outer anchor sleeve including an peripheral groove formed in said middle portion thereof to facilitate bending of said middle portion of said outer anchor sleeve,
an insert engageable into said bore of said outer anchor sleeve and including an outer end having an engaging hole formed therein for receiving a driving shank of a tool, and for allowing said insert to be rotated and driven by the driving shank, said insert including an outer thread formed thereon for threading with said inner thread of said outer anchor sleeve, and including an inner end portion, and
a drill element secured to said inner end portion of said insert, to allow said drill element to be rotated and driven by said insert, and
said drill element being rotatable by the driving shank via said insert for drilling into the wall member, and for engaging said outer anchor sleeve into the wall member until said peripheral lip of said outer anchor sleeve is engaged with the wall member, and said outer thread of said insert being threadable with said inner thread of said outer anchor sleeve when said peripheral lip of said outer anchor sleeve is engaged with the wall member, to expand said middle portion of said outer anchor sleeve, and to force said at least one peripheral flange to engaged into the wall member, and to solidly secure said outer anchor sleeve to the wall member.

2-5. (canceled)

6. The wall anchor device as claimed in claim 1, wherein said outer anchor sleeve includes a cone-shaped opening formed in said outer end portion thereof and communicating with said bore thereof, and said insert includes an enlarged head formed on said outer end thereof and receivable in said cone-shaped opening of said outer anchor sleeve.
